(19) United States
(12) Patent Application Publication
(10) Pub. No.: US 2024/0399961 A1
(43) Pub. Date: Dec. 5, 2024

(54) AUTOMOBILE DUAL-CAMERA MONITOR SYSTEM

(71) Applicant: Feng ZHANG, Xiamen (CN)

(72) Inventor: Feng ZHANG, Xiamen (CN)

(21) Appl. No.: 18/731,186

(22) Filed: May 31, 2024

(30) Foreign Application Priority Data
May 9, 2024 (CN) 202420986275.6

(51) Int. Cl. B60R 1/29; B60R 1/00; B60R 11/00; B60R 11/04

(52) U.S. Cl. CPC B60R 1/29; B60R 1/008; B60R 11/04; B60R 2011/0017; B60R 2011/0071; B60R 2300/105; B60R 2300/8013

(57) ABSTRACT

The disclosure belongs to the field of monitoring equipment and provides an automobile dual-camera monitor system, including a first camera, a second camera, a transmission line and a display, the first camera and the second camera being fixed in an automobile through a first fixing assembly and a second fixing assembly respectively, and a camera end of each of the first camera and the second camera facing a front end of a safety seat. With the above automobile dual-camera monitor system, in the process of driving, whether there are two infants sitting on rear-facing safety seats or two young children on forward-facing safety seats, or an infant on a rear-facing safety seat and a young child on a forward-facing safety seat in a rear seat, video signals captured by the first camera and the second camera are transmitted to the same display by means of wired transmission and displayed separately on split-screen, so that a driver can obtain a clear view of the two children in the process of driving without turning head to check on the children, improving the safety of driving.

### TECHNICAL FIELD

The disclosure relates to the technical field of monitoring equipment, and in particular, to an automobile dual-camera monitor system.

### BACKGROUND ART

The seat of each automobile is set according to the adult size, and the safety measures are mainly considered for adults, including seat belts, airbags, etc. Therefore, in order to better protect children, safety seats are usually installed on automobiles. However, in real life, the driver needs to look back to observe the state of the children in rear seat, causing the driver to look away from the road, which greatly reduces driving safety.

### SUMMARY OF THE INVENTION

The object of the disclosure is to provide an automobile dual-camera monitor system to solve the existing problem of low driving safety caused by a driver needing to turn back to look at the rear seat.

The disclosure provides an automobile dual-camera monitor system, including a first camera, a second camera, a transmission line and a display, wherein the transmission line is connected to the first camera and the second camera, the display is connected to the transmission line, the first camera and the second camera are fixed in an automobile through a first fixing assembly and a second fixing assembly respectively, and a camera end of each of the first camera and the second camera faces a front end of a safety seat.

With the above automobile dual-camera monitor system, in the process of driving, whether there are two infants sitting on rear-facing safety seats or two young children on forward-facing safety seats, or an infant on a rear-facing safety seat and a young child on a forward-facing safety seat in a rear seat, video signals captured by the first camera and the second camera are transmitted to the same display by means of wired transmission and displayed separately on split-screen, so that a driver can obtain a clear view of the two children in the process of driving without turning head to check on the children, improving the safety of driving.

Further, the display is provided with a plurality of sub-display modules, and each of the sub-display modules is respectively connected with the first camera and the second camera.

Further, the first fixing assembly includes four first fixing strips, first buckles arranged at the ends of the four first fixing strips, and a first camera mounting base arranged at a connection of the four first fixing strips, and the first camera is fixed on the first camera mounting base.

Further, the first camera mounting base includes a first fixing strip connecting plate, a first connecting threaded pipe arranged at one end of the first fixing strip connecting plate, a first fastening nut sleeved on an outer side of the first connecting threaded pipe, a first steering ball arranged in the first connecting threaded pipe, and a first camera connecting plate connected to the first steering ball.

Further, the first connecting threaded pipe is provided with an adjustment notch in a side wall, and an aperture of a free end of the first connecting threaded pipe is gradually reduced.

Further, the second fixing assembly includes four second fixing strips, two sets of second buckles arranged at the ends of the four second fixing strips, and a second camera mounting base arranged at a connection of the four second fixing strips, and the second camera is fixed on the second camera mounting base.

Further, the first camera includes a camera body, a photosensitive lens arranged at a front end of the camera body, and infrared lamps arranged at both sides of the photosensitive lens.

### BRIEF DESCRIPTION OF THE DRAWINGS

FIG. 1 is a schematic diagram of an automobile dual-camera monitor system in a first use state in an embodiment of the disclosure.

FIG. 2 is a schematic diagram of the automobile dual-camera monitor system in FIG. 1 in a driver's view.

FIG. 3 is a schematic diagram of an automobile dual-camera monitor system in a second use state in an embodiment of the disclosure.

FIG. 4 is a schematic diagram of the automobile dual-camera monitor system in FIG. 3 in a driver's view.

FIG. 5 is a schematic diagram of an automobile dual-camera monitor system in a third use state in an embodiment of the disclosure.

FIG. 6 is a schematic diagram of the automobile dual-camera monitor system in FIG. 5 in a driver's view.

FIG. 7 is a schematic diagram of a first camera mounting base in the automobile dual-camera monitor system in FIG. 1.

FIG. 8 is a front view of a first camera in the automobile dual-camera monitor system in FIG. 1.

FIG. 9 is a reference diagram illustrating the use of four first fixing strips in the automobile dual-camera monitor system in FIG. 1.

FIG. 10 is a schematic diagram of an installation state of the first camera in the automobile dual-camera monitor system of FIG. 1.

The following description will further illustrate the disclosure in combination with the above-mentioned drawings.

### DETAILED DESCRIPTION OF THE INVENTION

In order to facilitate the understanding of the disclosure, a more comprehensive description of the disclosure will be made below with reference to the relevant drawings. Several embodiments of the disclosure are given in the drawings. However, the disclosure can be implemented in many different forms and is not limited to the embodiments described herein. Rather, these embodiments are provided to make the content of the disclosure more thorough and comprehensive.

It should be noted that when an element is said to be “fixed” to another element, it may be directly on the other element or there may be a centered element. When an element is said to be “connected” to another element, it may be directly connected to the other element or there may be a centered element at the same time. The terms “vertical”, “horizontal”, “left”, “right” and similar expressions used herein are for illustrative purposes only.

Unless otherwise defined, all technical and scientific terms used herein have the same meaning as commonly understood by those skilled in the art of the disclosure. Terms used herein in the description of the disclosure are for the purpose of describing embodiments only and are not intended to limit the disclosure. The term “and/or” as used herein includes any and all combinations of one or more relevant listed items.

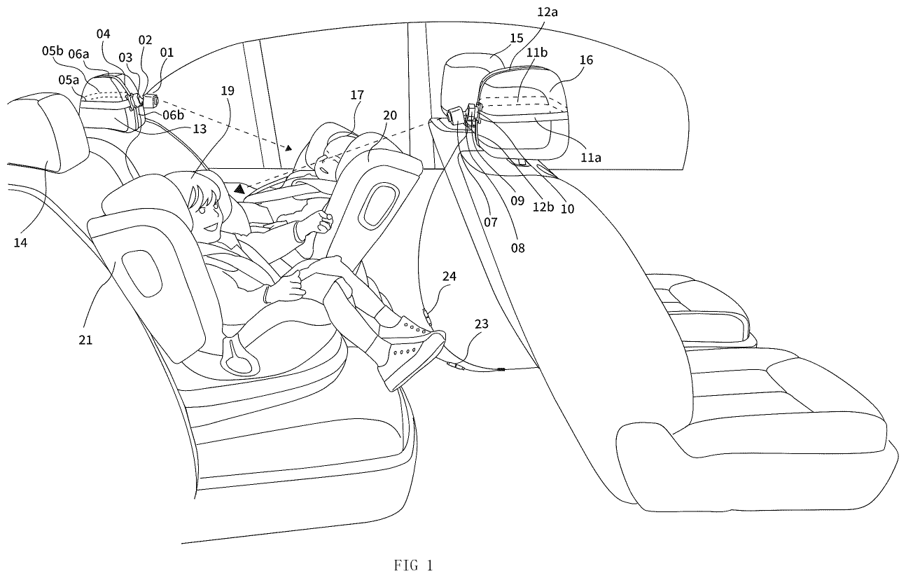

Referring to FIG. 1, the disclosure provides an automobile dual-camera monitor system, including a first camera 01, a second camera 07, two transmission lines 23 connected to the first camera 01 and the second camera 07, and a display 25 connected to the transmission line, the first camera 01 and the second camera 07 being fixed in an automobile through a first fixing assembly and a second fixing assembly respectively, and a camera end of each of the first camera 01 and the second camera 07 being facing a front end of a safety seat.

With the above automobile dual-camera monitor system, in the process of driving, whether there are two infants sitting on rear-facing safety seats or two young children on forward-facing safety seats, or an infant on a rear-facing safety seat and a young child on a forward-facing safety seat in a rear seat, video signals captured by the first camera 01 and the second camera 07 are transmitted to the same display 25 by means of wired transmission and displayed separately on split-screen, so that a driver can obtain a clear view of the two children in the process of driving without turning head to check on the children, improving the safety of driving.

Correspondingly, the display 25 is provided with a plurality of sub-display modules, and each of the sub-display modules is respectively connected to the first camera 01 and the second camera 07 to display the picture separately on a split screen.

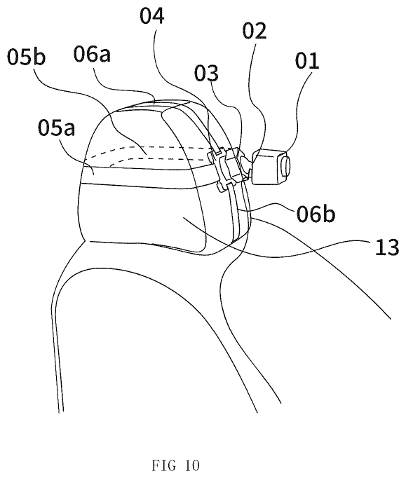

Referring to FIG. 10, in an embodiment of the disclosure, the first fixing assembly includes four first fixing strips 5a, 5b, 6a, 6b, a first buckle arranged at an end of each of the four first fixing strips 5a, 5b, 6a, 6b, and a first camera mounting base arranged at a connection of the four first fixing strips 5a, 5b, 6a, 6b, and the first camera 01 being fixed on the first camera mounting base.

In an embodiment of the disclosure, the first camera mounting base includes a first fixing strip connecting plate 04, a first connecting threaded pipe (not shown) arranged at one end of the first fixing strip connecting plate, a first fastening nut 03 sleeved on an outer side of the first connecting threaded pipe, a first steering ball 02 arranged in the first connecting threaded pipe 03, and a first camera connecting plate (not shown) connected to the first steering ball 02.

In an embodiment of the disclosure, the second fixing assembly includes four second fixing strips 11a, 11b, 12a, 12b, two sets of second buckles arranged at the ends of the four second fixing strips 11a, 11b, 12a, 12b, and a second camera mounting base arranged at the connection of the four second fixing strips 11a, 11b, 12a, 12b, and the second camera 07 being fixed on the second camera mounting base. The second camera mounting base includes a second fixing strip connecting plate 08, a second connecting threaded pipe (not shown) arranged at one end of the second fixing strip connecting plate 08, a second fastening nut 09 sleeved on an outer side of the second connecting threaded pipe 09, a second steering ball 10 arranged in the second connecting threaded pipe 09, and a second camera connecting plate (not shown) connected to the second steering ball 10.

Specifically, FIG. 1 illustrates that the first camera 01 is fixed on a rear seat left headrest 13 by the first steering ball 02, the first connecting threaded pipe 03, the first fixing strip connecting plate 04 and the four first fixing strips 5a, 5b, 6a, 6b in the camera mounting base, and the second camera 07 is fixed on a copilot seat headrest 16 by the second steering ball 08, the second connecting threaded pipe 09, the second fixing strip connecting plate 10 and the four second fixing strips 11a, 11b, 12a, 12b. By adjusting the first steering ball 02, the first connecting threaded pipe 03, the second steering ball 08, and the second connecting threaded pipe 09, the angle of the first camera 01 and the second camera 07 can be adjusted, and the cameras can focus on the children, and the image of a child 17 sitting on an rear-facing safety seat 20 captured by the first camera 01 is transmitted to the display 26 through the transmission line 23, and the image of a child 19 sitting on a forward-facing safety seat 21 captured by the second camera 07 is transmitted to the display 25 through the transmission line 24.

In an embodiment of the disclosure, the first connecting threaded pipe is provided with an adjustment notch in a side wall, and an aperture of a free end of the first connecting threaded pipe is gradually reduced. When the first fastening nut 03 is screwed, the first connecting threaded pipe can be closed to squeeze the first steering ball 02, thereby fixing the angle of the first camera 01.

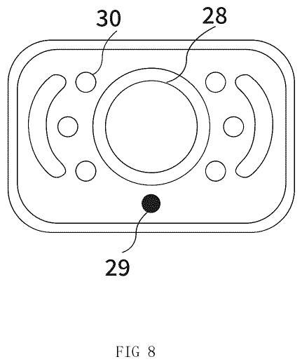

Referring to FIG. 8, in an embodiment of the disclosure, the first camera 01 includes a camera body 29, a photosensitive lens 28 arranged at a front end of the camera body 29, and infrared lamps 30 arranged at both sides of the photosensitive lens 28, so as to have a better shooting effect even when the light is dim, and be used for shooting video in a dark, unlit environment.

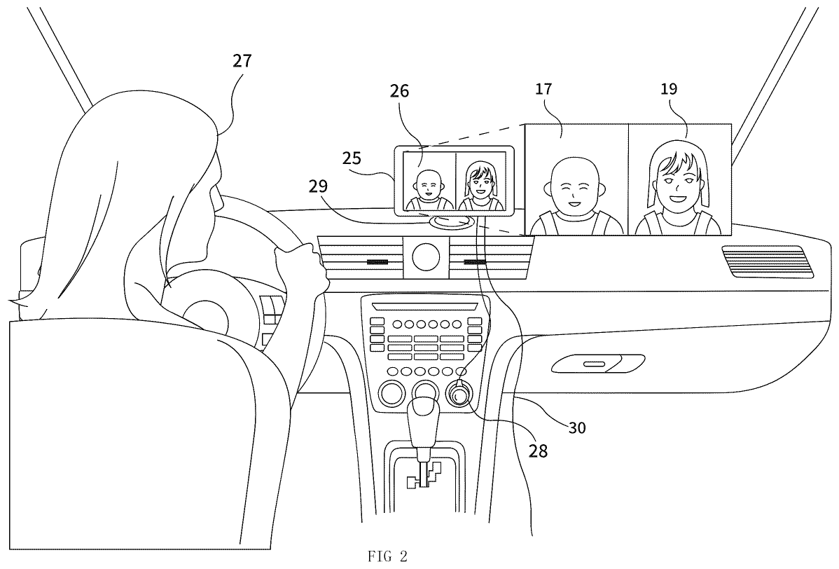

FIG. 2 illustrates that a driver 27 views a screen displayed on the display 25 in the process of driving, the display 25 is powered by a cigarette lighter 28 and fixed to a dashboard of the automobile by a bracket 29, the image of the video signal is displayed on a split-screen on a display screen 26 through a transmission line 30, and an image 17 and an image 19 are displayed on a split screen on the display screen of view of a child 17 seated in a rear-facing safety seat on the left side of the rear seat, and a child 19 seated in a forward-facing safety seat on the right side of the rear seat of the automobile.

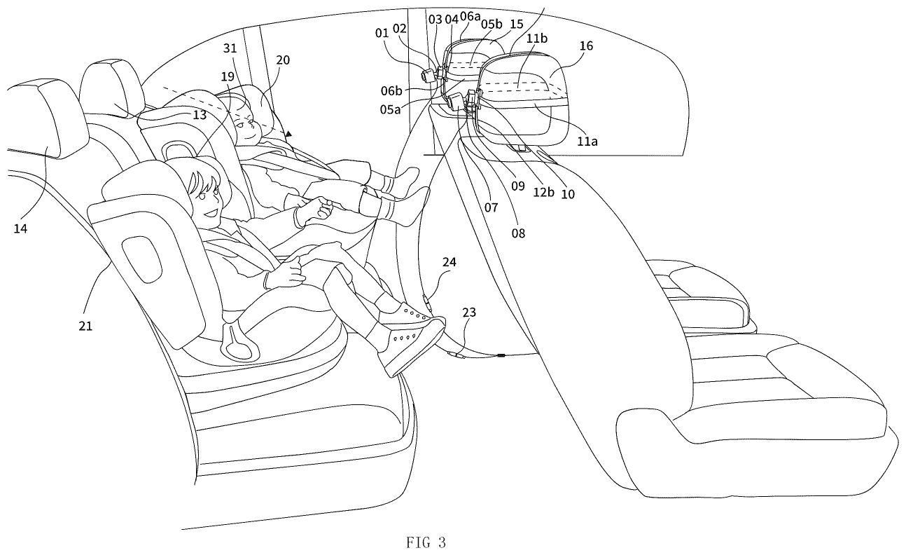

FIG. 3 illustrates that the first camera 01 is fixed on a driver's seat headrest 15 by the first steering ball 02 of the ball structure accessory, the first connecting threaded pipe 03, the first fixing strip connecting plate 04 and the four first fixing strips 5a, 5b, 6a, 6b; and the second camera 07 is fixed on a copilot seat headrest 16 by the second steering ball 08, the second connecting threaded pipe 09, the second fixing strip connecting plate 10 and the four second fixing strips 11a, 11b, 12a, 12b. By adjusting the first steering ball 02 of the accessory, the first connecting threaded pipe 03, the second steering ball 08, and the second connecting threaded pipe 09, the cameras can focus on the children, and the image of a child 31 sitting on an forward-facing safety seat 20 captured by the first camera 01 is transmitted to the display through the transmission line 23, and the image of a child 19 sitting on a forward-facing safety seat 21 captured by the second camera 07 is transmitted to the display through the transmission line 24.

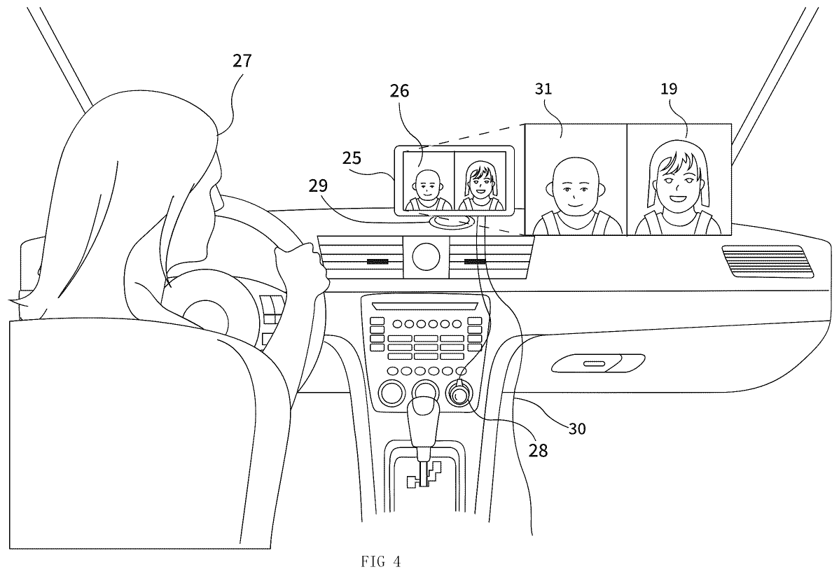

FIG. 4 illustrates that a driver 27 views a screen displayed on the display 25 in the process of driving, the display 25 is powered by the cigarette lighter 28 and fixed to the dashboard of the automobile by the bracket 29, the image of the video signal is displayed on a split-screen on a display screen 26 through a transmission line 30, and an image 31 and an image 19 are displayed on a split screen on the display screen of view of a child 31 seated in a forward-facing safety seat on the left side of the rear seat, and a child 19 seated in a forward-facing safety seat on the right side of the rear seat of the automobile.

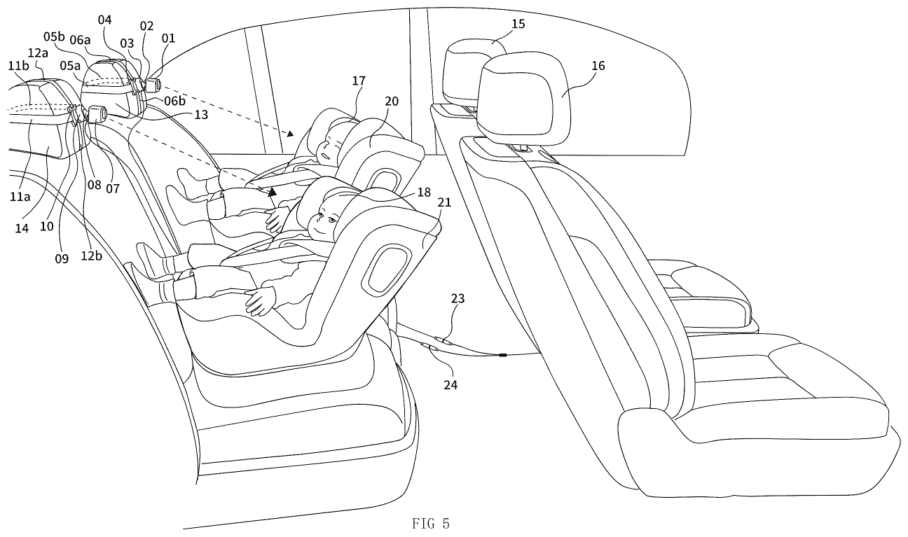

FIG. 5 illustrates that the camera 01 is fixed on the left headrest 13 on the rear seat by the first steering ball 02, the first connecting threaded pipe 03, the first fixing strip connecting plate 04 and the four first fixing strips 5a, 5b, 6a, 6b; and the second camera 07 is fixed on the right headrest 14 on the rear seat by the second steering ball 08, the second connecting threaded pipe 09, the second fixing strip connecting plate 10 and the second fixing strips 11a, 11b, 12a, 12b. By adjusting the first steering ball 02, the first connecting threaded pipe 03, the second steering ball 08, and the second connecting threaded pipe 09, the cameras can focus on the children, and the image of the child 17 sitting on the rear-facing safety seat 20 captured by the first camera 01 is transmitted to the display through the transmission line 23, and the image of a child 18 sitting on the rear-facing safety seat 21 captured by the camera 7 is transmitted to the display through the transmission line 24.

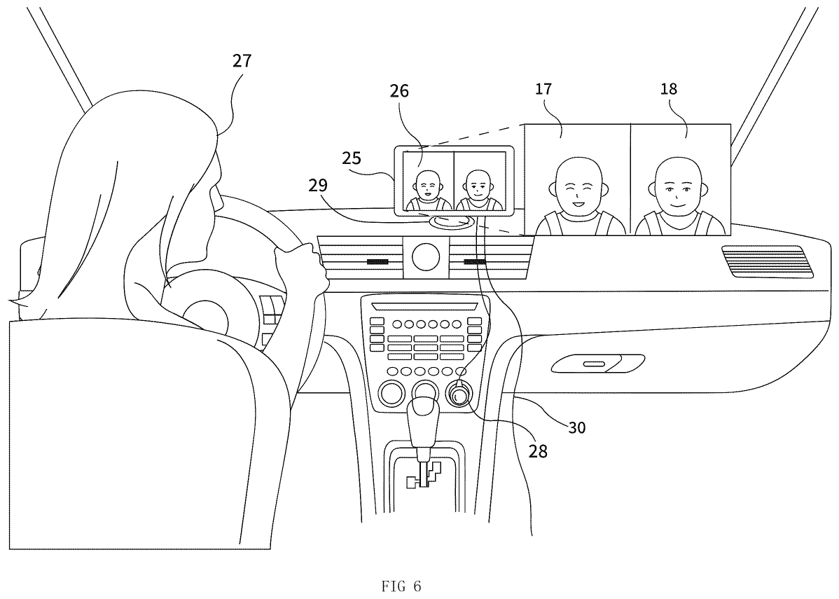

FIG. 6 illustrates that the driver 27 views a screen displayed on the display 25 in the process of driving, the display 25 is powered by the cigarette lighter 28 and fixed to the dashboard of the automobile by the bracket 29, the image of the video signal displaying in a split-screen on a display screen 26 through a transmission line 30, and the images 17 and 18 are displayed on a split screen on the display screen of view of a child 17 seated in a rear-facing safety seat and a child 18 seated in a rear-facing safety seat of the automobile.

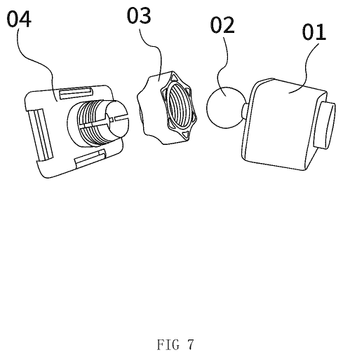

FIG. 7 illustrates that the first camera 01 is fixed by the first steering ball 02, the first connecting threaded pipe 03, and the first fixing strip connecting plate 04; and the first connecting threaded pipe 03 and the first fixing strip connecting plate 04 are fixed by threading the first steering ball 02.

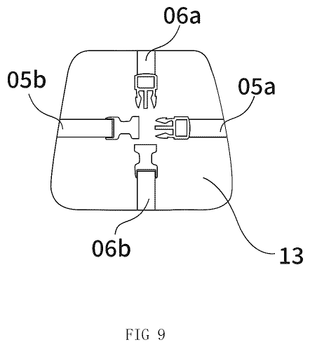

FIG. 9 illustrates a rear view of the first camera 01 when fixed on a headrest of the automobile, with the four first fixing strips 5a, 5b, 6a, 6b fixed relative to each other, as shown in FIG. 10, the camera can be fixed in any area of the rear seat headrest and is movable in all directions, so that the camera can focus on the child.

The above embodiments only express several embodiments of the disclosure, and the descriptions are specific and detailed, but are not to be construed as a limitation of the patent scope of the disclosure. It should be pointed out that, for those ordinary skilled in the art, deformations and improvements can be made without departing from the conception of the disclosure, which all belong to the scope of protection of the disclosure. The scope of protection of the disclosure shall be subject to the attached claims.

1. An automobile dual-camera monitor system, comprising a first camera, a second camera, a transmission line and a display, wherein the transmission line is connected to the first camera and the second camera, the display is connected to the transmission line, the first camera and the second camera are fixed in an automobile through a first fixing assembly and a second fixing assembly respectively, and a camera end of each of the first camera and the second camera faces a front end of a safety seat.

2. The automobile dual-camera monitor system according to claim 1, wherein the display is provided with a plurality of sub-display modules, and each of the sub-display modules is respectively connected with the first camera and the second camera.

3. The automobile dual-camera monitor system according to claim 1, wherein the first fixing assembly comprises four first fixing strips, first buckles arranged at the ends of the four first fixing strips, and a first camera mounting base arranged at a connection of the four first fixing strips, and the first camera is fixed on the first camera mounting base.

4. The automobile dual-camera monitor system according to claim 3, wherein the first camera mounting base comprises a first fixing strip connecting plate, a first connecting threaded pipe arranged at one end of the first fixing strip connecting plate, a first fastening nut sleeved on an outer side of the first connecting threaded pipe, a first steering ball arranged in the first connecting threaded pipe, and a first camera connecting plate connected to the first steering ball.

5. The automobile dual-camera monitor system according to claim 4, wherein the first connecting threaded pipe is provided with an adjustment notch in a side wall, and an aperture of a free end of the first connecting threaded pipe is gradually reduced.

6. The automobile dual-camera monitor system according to claim 1, wherein the second fixing assembly comprises four second fixing strips, two sets of second buckles arranged at the ends of the four second fixing strips, and a second camera mounting base arranged at a connection of the four second fixing strips, and the second camera is fixed on the second camera mounting base.

7. The automobile dual-camera monitor system according to claim 1, wherein the first camera comprises a camera body, a photosensitive lens arranged at a front end of the camera body, and infrared lamps arranged at both sides of the photosensitive lens.
